(19) United States
(12) Patent Application Publication
(10) Pub. No.: US 2022/0277065 A1
(43) Pub. Date: Sep. 1, 2022

(54) AUTHENTICATION USING STORED AUTHENTICATION IMAGE DATA

(71) Applicant: Jumio Corporation, Palo Alto, CA (US)

(72) Inventors: Labhesh PATEL, Santa Clara, CA (US); Philipp POINTNER, Vienna (AT)

(21) Appl. No.: 17/747,698

(22) Filed: May 18, 2022

Related U.S. Application Data
(63) Continuation of application No. PCT/US20/59858, filed on Nov. 10, 2020.
(60) Provisional application No. 62/938,779, filed on Nov. 21, 2019.

(51) Int. Cl. G06F 21/32

(52) U.S. Cl. CPC G06F 21/32

(57) ABSTRACT

Computer systems and methods are provided for authenticating a user. A system receives first authentication information that includes first and second facial image data for a user. The system compares the first facial image with the second facial image to determine whether first matching criteria are met. The system, in accordance with a determination that the first matching criteria are met, generates an identity chain. The system, after generating the identity chain, receives a request to perform a transaction and receiving second authentication information that includes third facial image data for the user. The system determines whether the third facial image meets second matching criteria by comparing the third facial image with respective image data of the identity chain. The system, in accordance with a determination that the third facial image user meets the second matching criteria, transmits authorization information for the transaction.

### RELATED AND PRIORITY APPLICATIONS

This application is a continuation of International App. No. PCT/US20/59858, filed Nov. 10, 2020, which claims priority to U.S. Prov. App No. 62/938,779, filed Nov. 21, 2019; each of which is hereby incorporated by reference in its entirety.

### TECHNICAL FIELD

This application relates generally to user authentication, and more particularly, to using facial image data for user authentication.

### BACKGROUND

User authentication is often performed prior to granting user access to a system. Typically, user authentication involves accessing previously stored user information, such as user identification information and/or user biometric data, and comparing the previously stored user information with information that a user provides in connection with an access request. Systems that perform user authentication store user information in a data storage device. Prior to requesting authorization, users enroll with the system by providing user information to be stored.

### SUMMARY

Some authentication systems described herein perform authentication using a newly-captured facial image and identity chain of an authenticated person that includes at least the person's face and a document that includes a previously-captured image of the person's face. For example, a person who has previously been verified, authenticated or granted authorization, submits a request for a subsequent authorization. In response to the request (e.g., from a user device), a facial image is received. Image analysis is performed on the received facial image to determine facial image data. The facial image data is further analyzed to determine whether the person's face in the image matches a facial image in the identity chain. If the image analysis determines that there is a match, authorization is granted. In some embodiments, if authorization is granted, the received facial image is stored to the identity chain for future comparisons. In some embodiments, after the received facial image is stored to the identity chain, the matching criteria is updated. In this way, the system promotes continuous learning by increasing the sample of facial images available to use in the matching criteria and other processes. As such, a device is enabled to perform re-authentication using the newly received facial image without requiring a user to request a full authentication or submit identification documentation a second time.

In some embodiments, a method is performed at a server system including one or more processors and memory storing one or more programs for execution by the one or more processors. The method includes receiving first authentication information that includes first facial image data for a user and second facial image data for the user, where the first facial image data for the user is distinct from the second facial image data for the user. The method includes comparing the first facial image data for the user with the second facial image data for the user to determine whether first matching criteria are met. The method includes, in accordance with a determination that the first matching criteria are met, generating an identity chain that includes at least one of the first facial image data for the user or the second facial image data for the user. The method further includes, after generating the identity chain, receiving a request to perform a first transaction and receiving second authentication information that includes third facial image data for the user. The method includes determining whether the third facial image data for the user meets second matching criteria by comparing the third facial image data for the user with facial image data for a respective image of the identity chain. The method includes, in accordance with a determination that the third facial image data for the user meets the second matching criteria, transmitting authorization information for the first transaction.

In accordance with some embodiments, an electronic device (e.g., a server system, a client device, etc.) includes one or more processors and memory storing one or more programs configured to be executed by the one or more processors. The one or more programs include instructions for performing the operations of the method described above. In accordance with some embodiments, a computer-readable storage medium has stored therein instructions that, when executed by an electronic device, cause the server system to perform the operations of the method described above.

### BRIEF DESCRIPTION OF THE DRAWINGS

So that the present disclosure can be understood in greater detail, features of various embodiments are illustrated in the appended drawings. The appended drawings, however, merely illustrate pertinent features of the present disclosure and are therefore not limiting.

FIG. 1 is a system diagram of a computing system and its context, in accordance with some embodiments.

FIG. 2 is a system diagram of an image capturing device, in accordance with some embodiments.

FIG. 3 illustrates a document that includes a facial image, in accordance with some embodiments.

FIGS. 4 and 5 illustrate image comparisons for user authentication, in accordance with some embodiments.

FIGS. 6A-6C, 7A, and 7B illustrate captured images that include a user facial image and an image of a document that includes another facial image of the user, in accordance with some embodiments.

FIG. 8A illustrates a first state of a user interface that displays a moving target for liveness verification, in accordance with some embodiments.

FIG. 8B illustrates an image that is captured while the moving target of FIG. 8A is displayed, in accordance with some embodiments.

FIG. 9A illustrates a second state of a user interface that displays a moving target for liveness verification, in accordance with some embodiments.

FIG. 9B illustrates an image that is captured while the moving target of FIG. 9A is displayed, in accordance with some embodiments.

FIGS. 10A-10B illustrate movement of an eye relative to movement of a facial image while the moving target of FIGS. 8A and 9A is displayed, in accordance with some embodiments.

FIG. 11A illustrates a first state of a user interface that displays language content for liveness verification, in accordance with some embodiments.

FIG. 11B illustrates an image that is captured while the language content of FIG. 11A displayed, in accordance with some embodiments.

FIG. 12A illustrates a second state of a user interface that displays language content for liveness verification, in accordance with some embodiments.

FIG. 12B illustrates an image that is captured while the language content of FIG. 12A displayed, in accordance with some embodiments.

FIGS. 13A-13D are flow diagrams illustrating a method for authenticating a user using facial image comparison, in accordance with some embodiments.

FIGS. 14A-14B illustrate a flow diagram illustrating a method of authenticating, in accordance with some embodiments.

In accordance with common practice, some of the drawings may not depict all of the components of a given system, method, or device. Finally, like reference numerals denote like features throughout the specification and figures.

### DETAILED DESCRIPTION

Numerous details are described herein in order to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not been described in exhaustive detail so as not to unnecessarily obscure pertinent aspects of the embodiments described herein.

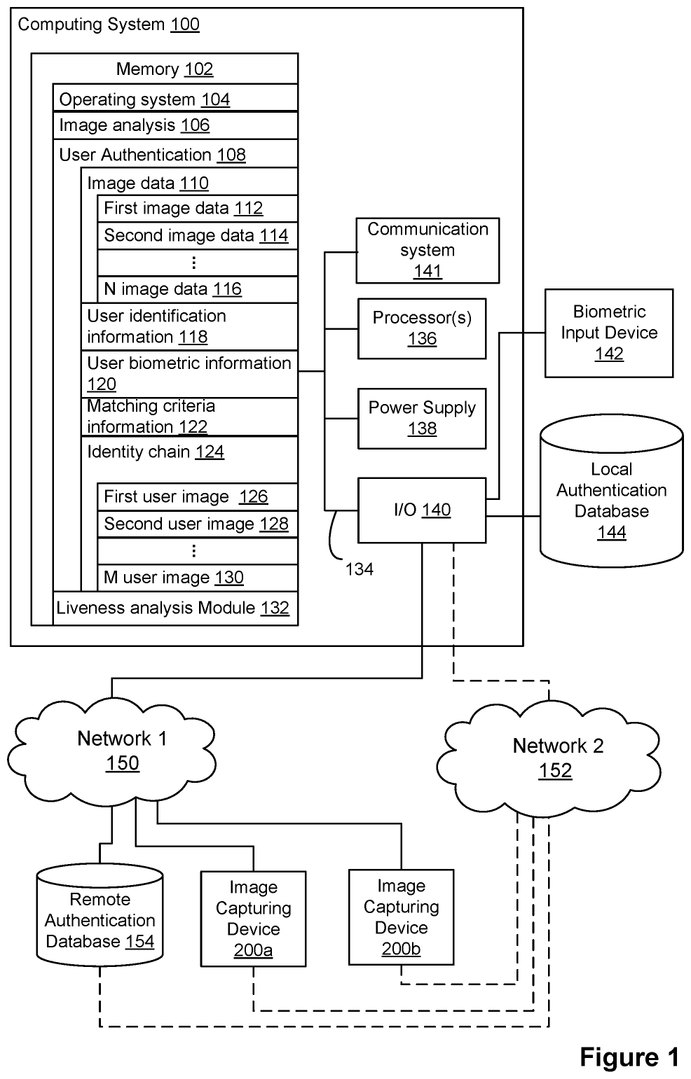

FIG. 1 is a system diagram of a computing system 100, in accordance with some embodiments. The computing system 100 is, for example, a server computer, a desktop computer, or a laptop computer. The computing system 100 typically includes a memory 102, one or more processor(s) 136, a power supply 138, an input/output (I/O) subsystem 140, and a communication bus 134 for interconnecting these components.

The processor(s) 136 execute modules, programs, and/or instructions stored in the memory 102 and thereby perform processing operations.

In some embodiments, the memory 102 stores one or more programs (e.g., sets of instructions) and/or data structures, collectively referred to as “modules” herein. In some embodiments, the memory 102, or the computer readable storage medium (e.g., a non-transitory computer-readable storage medium) of the memory 102, or a computer program product stores the following programs, modules, and data structures, or a subset or superset thereof:
an operating system 104;
an image analysis module 106;
a user authentication module 108, which stores information such as image data 110, extracted first image data 112, extracted second image data 114, up to extracted N image data 116 (e.g., extracted by the image analysis module 106 from the captured image data 110), user identification information 118 (e.g., user name, user password, user residential information, user phone number, user date of birth, and/or user e-mail), and user biometric information 120 (e.g., facial data, fingerprint data, retinal data, hand image data, and/or gait data), matching criteria information 122; identity chain 124 which includes user images (e.g., first user image 126, second user image 128, up to M user image 130) based on authentication of the user (e.g., satisfying matching criteria information 122) and is used to update matching criteria information 122; and
liveness analysis module 132, which stores information for displaying a moving target liveness user interface 800 and/or a language content liveness user interface 1100, generates audio output including facial movement instructions and/or language content, stores verification data (e.g., facial feature position data, audio print data that corresponds to language content output, and/or facial image data that corresponds to language content output), and/or uses an audio analysis module to perform audio analysis.

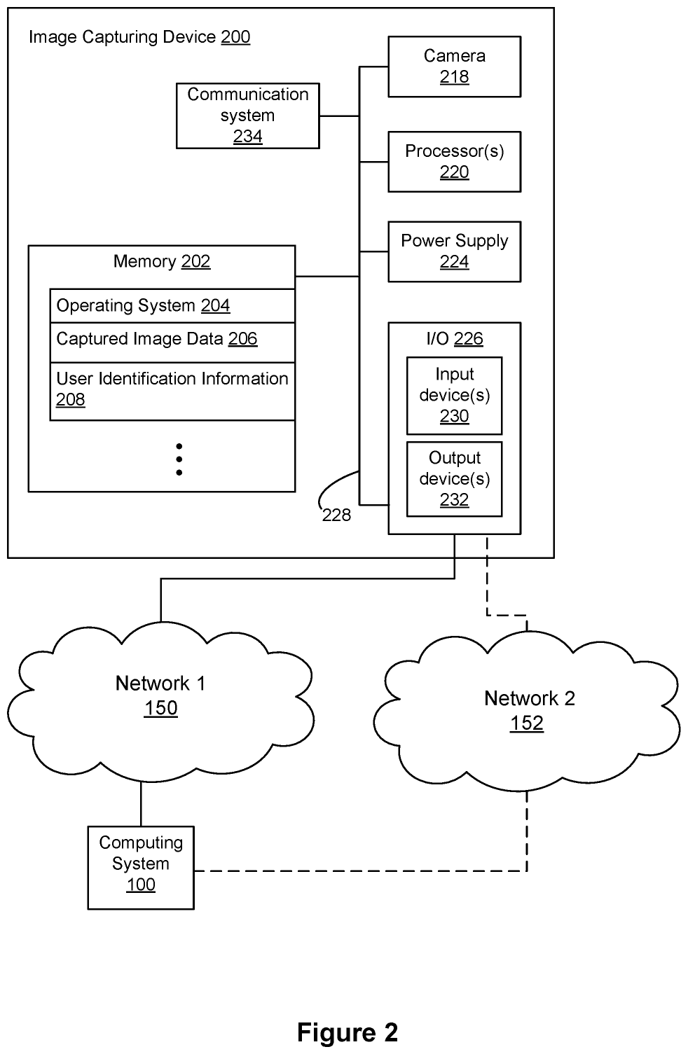

The above identified modules (e.g., data structures, and/or programs including sets of instructions) need not be implemented as separate software programs, procedures, or modules, and thus various subsets of these modules may be combined or otherwise re-arranged in various embodiments. In some embodiments, the memory 102 stores a subset of the modules identified above. In some embodiments, a remote authentication database 154 and/or a local authentication database 144 store one or more modules identified above. Furthermore, the memory 102 may store additional modules not described above. In some embodiments, the modules stored in the memory 102, or a non-transitory computer readable storage medium of the memory 102, provide instructions for implementing respective operations in the methods described below. In some embodiments, some or all of these modules may be implemented with specialized hardware circuits that subsume part or all of the module functionality. One or more of the above identified elements may be executed by one or more of the processor(s) 136. In some embodiments, one or more of the modules described with regard to the memory 102 is implemented in the memory 202 of an image capturing device 200 (FIG. 2) and executed by the processor(s) 220 of the image capturing device 200.

In some embodiments, the I/O subsystem 140 communicatively couples the computing system 100 to one or more local devices, such as a biometric input device 142 and/or a local authentication database 144, via a wired and/or wireless connection. In some embodiments, the I/O subsystem 140 communicatively couples the computing system 100 to one or more remote devices, such as a remote authentication database 154, a first image capturing device 200a, and/or a second image capturing device 200b, via a first communications network 150, a second communications network 152, and/or via a wired and/or wireless connection. In some embodiments, the first communications network 150 is the Internet. In some embodiments, the first communication network 150 is a first financial network and the second communication network 152 is a second financial network.

In some embodiments, a biometric input device 142 (e.g., a fingerprint scanner, a retinal scanner, and/or a camera) is communicatively coupled to the computing system 100. For example, the computing system 100 is located in or near to an authentication kiosk, or is communicatively coupled to an authentication kiosk that includes the biometric input device 142.

The communication bus 134 optionally includes circuitry (sometimes called a chipset) that interconnects and controls communications between system components.

FIG. 2 is a system diagram of an image capturing device 200 (e.g., the first or second image capturing devices 200a or 200b), in accordance with some embodiments. The image capturing device 200 typically includes a memory 202, a camera 218, one or more processor(s) 220, a power supply 224, an input/output (I/O) subsystem 226, and a communication bus 228 for interconnecting these components. The image capturing device 200 is, for example, a mobile phone, a tablet, a digital camera, a laptop computer or other computing device, or a kiosk.

The processor(s) 220 execute modules, programs, and/or instructions stored in the memory 202 and thereby perform processing operations.

In some embodiments, the memory 202 stores one or more programs (e.g., sets of instructions) and/or data structures, collectively referred to as “modules” herein. In some embodiments, the memory 202, or the non-transitory computer readable storage medium of the memory 202 stores the following programs, modules, and data structures, or a subset or superset thereof:
an operating system 204;
captured image data 206 (e.g., image data captured by the camera 218, such as video and/or still images); and
user identification information 208 (e.g., user name, user password, user residential information, user phone number, user date of birth, and/or user e-mail address).

The above identified modules (e.g., data structures, and/or programs including sets of instructions) need not be implemented as separate software programs, procedures, or modules, and thus various subsets of these modules may be combined or otherwise re-arranged in various embodiments. In some embodiments, the memory 202 stores a subset of the modules identified above. In some embodiments, the camera 218 stores one or more modules identified above (e.g., captured image data 206). Furthermore, the memory 202 may store additional modules not described above. In some embodiments, the modules stored in the memory 202, or a non-transitory computer readable storage medium of the memory 202, provide instructions for implementing respective operations in the methods described below. In some embodiments, some or all of these modules may be implemented with specialized hardware circuits that subsume part or all of the module functionality. One or more of the above identified elements may be executed by one or more of the processor(s) 220. In some embodiments, one or more of the modules described with regard to the memory 202 is implemented in the memory 102 of the computing system 100 and executed by processor(s) 136 of the computing system 100.

The camera 218 captures still images, sequences of images, and/or video. In some embodiments, the camera 218 is a digital camera that includes an image sensor and one or more optical devices. The image sensor is, for example, a charge-coupled device or other pixel sensor that detects light. In some embodiments, one or more optical devices are movable relative to the image sensor by an imaging device actuator. The one or more optical devices affect the focus of light that arrives at the image sensor and/or an image zoom property.

In some embodiments, the image capturing device 200 includes a camera 218 (e.g., the camera 218 is located within a housing of the image capturing device 200). In some embodiments, the camera 218 is a peripheral device that captures images and sends captured image data 206 to the I/O subsystem 226 of the image capturing device 200 via a wired and/or wireless communication connection.

In some embodiments, the I/O subsystem 226 communicatively couples image capturing device 200 to one or more remote devices, such as a computing system 100, via a first communication network 150 and/or a second communication network 152.

In some embodiments, a user input device 230 and/or an output device 232 are integrated with the image capturing device 200 (e.g., as a touchscreen display). In some embodiments, a user input device 230 and/or an output device 232 are peripheral devices communicatively connected to an image capturing device 200. In some embodiments, a user input device 230 includes a microphone, a keyboard, and/or a pointer device such as a mouse, a touchpad, a touchscreen, and/or a stylus. In some embodiments, the output device 232 includes a display (e.g., a touchscreen display that includes input device 230) and/or a speaker.

The communication bus 228 optionally includes circuitry (sometimes called a chipset) that interconnects and controls communications between system components.

In some embodiments, one or more user input devices and/or output devices (not shown), such as a display, touchscreen display, speaker, microphone, keypad, pointer control, zoom adjustment control, focus adjustment control, and/or exposure level adjustment control, are integrated with the device 200.

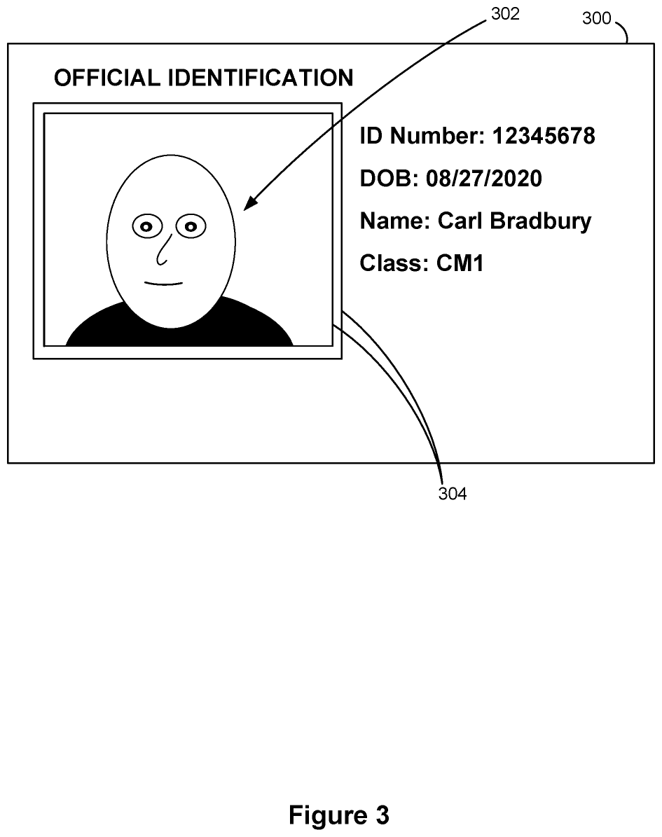

FIG. 3 illustrates a document 300 that includes an identification image 302, in accordance with some embodiments. The document 300 is, for example, a government issued identification, such as an identification card, a driver's license, a passport, etc.; a payment card (e.g., credit card or debit card); a facility access card; and/or a photograph. In some embodiments, the identification image 302 is a photograph and the document 300 is a photo identification.

In some embodiments, the document 300 includes facial image location cue information (e.g., the concentric rectangles indicated at 304). Facial image location cue information 304 is a visual indication on the document 300 of a location of the identification image 302 within the document 300. For example, the concentric rectangles 304 that surround identification image 302 provide a cue to indicate the location of the identification image 302 within the document 300. In some embodiments, facial image location cue information includes one or more marks and/or pointers. For example, facial image location cue information indicates a facial image area that is smaller than the full area of the document 300 and that includes the identification image 302, such as a perimeter that indicates boundaries of the identification image 302 or otherwise surrounds the identification image 302. In some embodiments, a facial image location cue is a background surrounding the identification image 302 (e.g., a background that has a predefined color and/or pattern). In some embodiments, a facial image location cue includes a material and/or texture of the facial image area of the document 300 that is different from a material and/or texture of the remainder of the document 300.

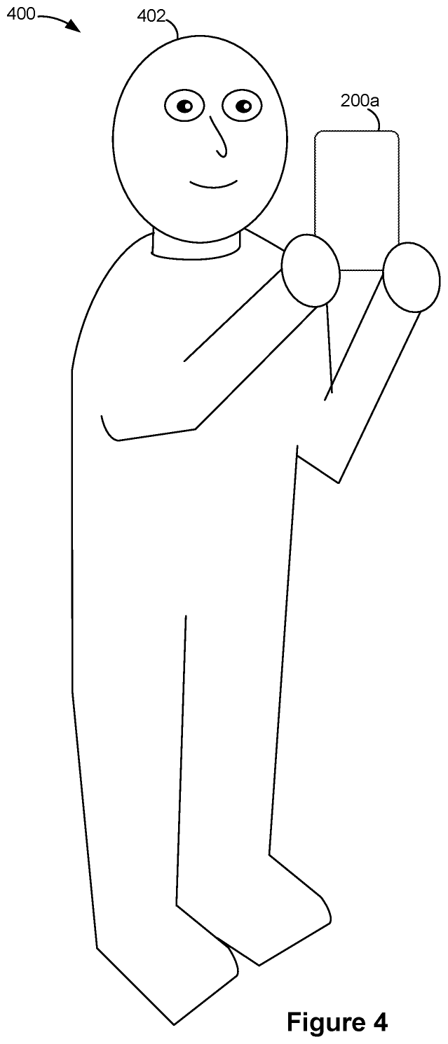

FIG. 4 illustrates an image capture environment 400, in accordance with some embodiments. In FIG. 4, a person 402 holding an image capturing device 200a (e.g., a mobile device). The image capturing device 200a is used to capture an image of the face and/or body of person 402. In some embodiments, the camera 218 is a front-facing camera of the image capturing device 200a, allowing the person 402 to adjust imaging properties of the camera 218 (e.g., a position and/or zoom level of the camera 218) while viewing the output of the camera 218 on a display (e.g., an output device 232) of the image capturing device 200a to ensure that the face of the person 402 is visible in an image frame captured by the camera 218.

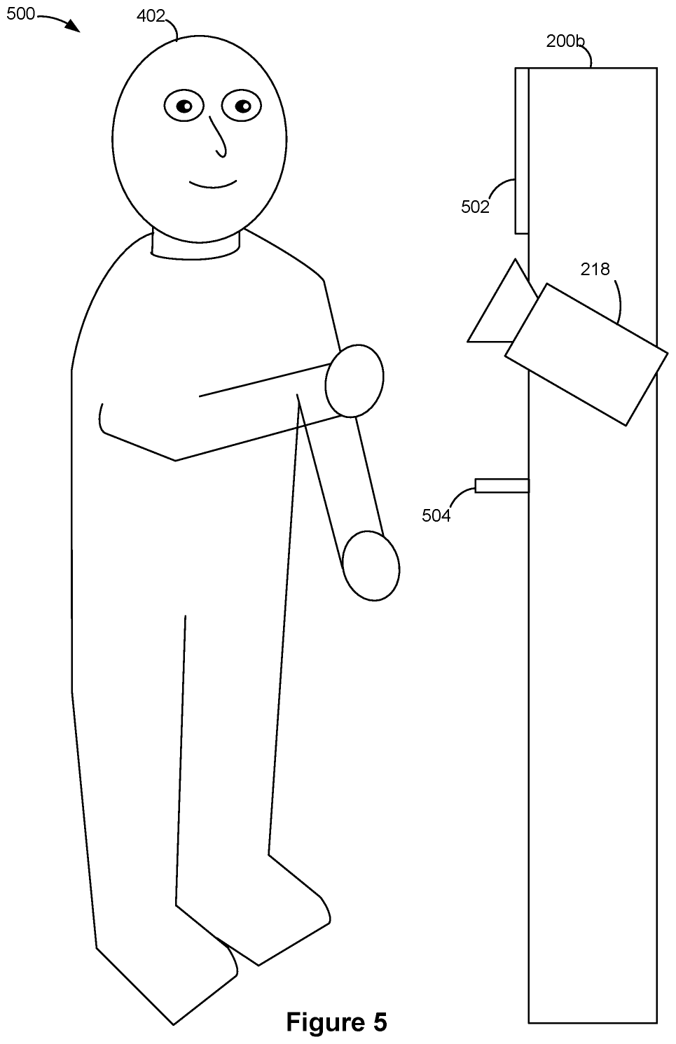

FIG. 5 illustrates an image capture environment 500, in accordance with some embodiments. In FIG. 5, the image capturing device 200b is a kiosk (or a component of a kiosk). The kiosk 200b is, for example, a security kiosk (e.g., for gaining entrance to an entertainment venue, an office, and/or a travel destination) or a commercial kiosk (e.g., a registration and/or check-out device for a commercial establishment such as a store or hotel). The kiosk 200b includes a camera 218 that captures an image in which the face of the person 402 is visible in a captured image frame. In some embodiments, the kiosk 200b includes one or more user input devices 504 and/or output devices 502.

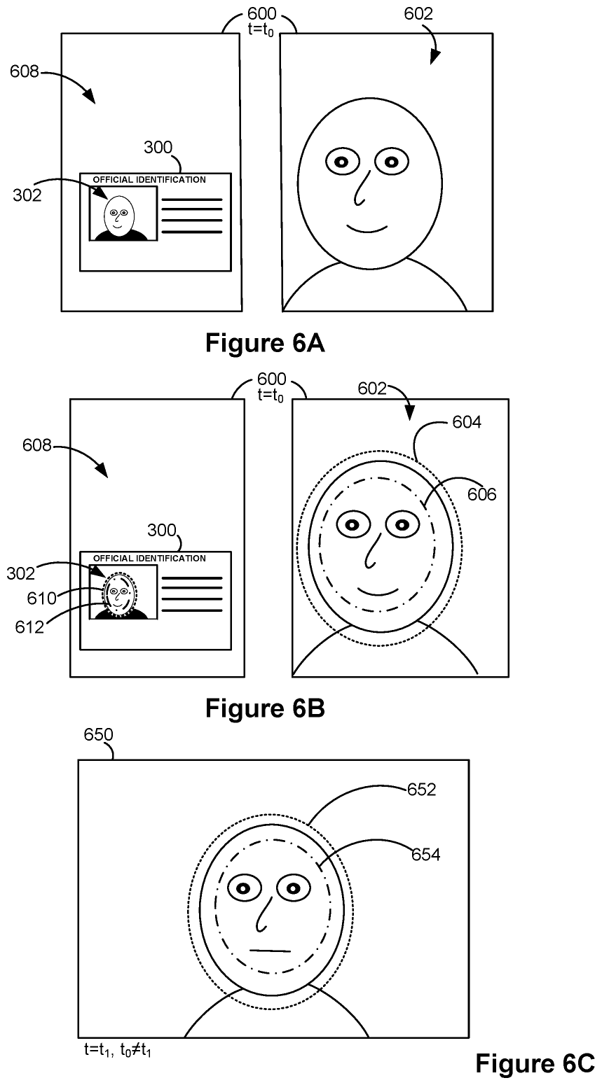

FIG. 6A illustrates generation of identity chain 600 by a user authentication and/or enrollment in accordance with some embodiments. In some embodiment, an identity chain 600 is a data structure, corresponding to a unique user 402 (or user account), stored in database. The data structure includes image data corresponding to one or more images of the user 402. As additional images are authenticated, image data for these images are added to the user's identity chain (e.g., added to the data structure). In some embodiments, the image data comprises the images themselves (e.g., the image data is a set of images included in the identity chain). In some embodiments, the image data corresponds to processed representations of the images (e.g., images of the user are passed to a hash function, the output of which is stored as the image data; images of the user are passed to a neural network, which produces vector representations of the images, etc.). In some embodiments, the image data is a set of processed representations of the images. The identity chain 600 is generated based on a comparison of first authentication information that includes user image data 602 (also referred to as a second image) of a person 402 (FIGS. 4 and 5) and image data 608 (also referred to as a first image) that includes document 300 and identification image 302. For example, if it is determined that the comparison of user image data 602 of a person 402 and document image data 608 meets first matching criteria, identity chain 600 is generated.

In some embodiments, authentication information is a representation of an authentication request sent over an electronic connection (e.g., from an image capturing device 200 to a server 100, via network 150, tasked with performing authentication). In some embodiments, the authentication information is sent in response to the authentication request. In some embodiments, the authentication information is a data structure that is sent from the image capturing device 200 to the server 100 in response to the user submitting a request for authentication at the image capturing device 200.

In some embodiments, the identity chain 600 is associated (e.g., rooted) to document 300 (e.g., via first facial image data 610 through the process define in FIGS. 6A-6C). In some embodiments, the identity chain 600 includes at least one of user image data 602 of a person 402 and/or document image data 608. In some embodiments, identity chain 600 includes first facial image data 610 and/or second facial image data 604 that is extracted from document image data 608 and/or the user image data 602 of the person 402, respectively. For example, in some embodiments, when identity chain 600 is generated, identity chain 600 may include second facial image data 604 and associate (e.g., root) the second facial image data 604 with document 300 (e.g., via first facial image data 610) such that the second facial image data 604 functions as a proxy to document 300. In some embodiments, each image included in the identity chain 600 is associated (e.g. rooted) with the image data 608 of the document (e.g., associating the second facial image data 604 and/or third facial image data 652 to the first facial image data 606 after first matching criteria and/or second criteria, respectively, has been met). For example, after comparing third facial image data 652 with a respective image of identity chain 600 and second matching criteria is met, the third facial image 652 is included in identity chain 600 and further associated (e.g., rooted) with document 300 such that the third facial image 652 functions as a proxy to document 300.

In some embodiments, the identity chain 600 is used to authenticate subsequent transactions. For example, the new images included in the identity chain and associated with document 300 (e.g., via first facial image data 610) are used to authenticate captured image data 650 for additional transactions. For purposes of this disclosure, a transaction is the execution of a particular action and/or agreement between the user and a third-party. The captured images (602, 608, 604, and/or 610) included in the identity chain 600 are received by an image capturing device 200 such as the first image capturing device 200a as described with regard to FIG. 4 or the second image capturing device 200b as described with regard to FIG. 5. In some embodiments, the captured images (602, 608, 604, and/or 610) in identity chain 600 are image frames from video sequences. In some embodiments, the captured images (602,608, 604, and/or 610) in identity chain 600 are image frames captured as single still images.

In FIG. 6B, the one or more facial image data that are used to generate identity chain 600 are shown annotated. In some embodiments, user image data 602 includes second facial image data 604 and second portion 606 (e.g., a subset of facial features) of the second facial image data 604. In some embodiments, image data 608 of the document that includes first facial image data 610 and first portion 612 of the first facial image 610. When generating the identity chain 600, the first facial image data 610 (e.g., of the image data of the document) is compared with the second facial image data 604 (e.g., of the user 402) to determine whether first matching criteria (e.g., initial authentication and/or enrollment) is met. For example, the face of person 402 extracted from user image data 602 (e.g. second facial image data 604) is compared with the extracted face of image data 608 of the document (e.g., first facial image data 610). In some embodiments, the first portion 612 of facial image data 610 is compared with the second portion 606 of second facial image data 604 to determine whether first matching criteria is met. For example, a portion of respective facial image data includes eyes, nose, mouth, less than all of a full face, etc. and respective portions of the facial image data are compared to determine whether the first matching criteria is met. In some embodiments, one or more parameters (e.g., shape of face, location of facial features such as eyes, mouth, and nose relative to one another and/or relative to an outline of the face, relative sizes of facial features, and/or distances between facial features) of facial image data for a respective image (e.g., first facial image data 610 and second facial image data 604) are determined and used to determine whether the first matching criteria are met.

While the illustrative regions indicated in FIG. 6B are ovals, it will be recognized that the user image data 602 and/or the identification image 302 in the document 300 may be rectangular regions, circular regions, polygonal regions, and/or regions that conform to detected outlines of the facial image data 608 and 602 and/or specific of facial features of the facial image data 608 and 602 (e.g., eyes, nose, mouth, less than all of a full face, etc.). “Facial image,” as used herein, refers to a face of a person 402, a portion of a face of the person 402, and/or a face and other parts of the body of the person 402 (e.g., the face and the person's shoulders or the person's entire body).

Based on a determination that the first matching criteria (e.g., facial comparison between the image data) has been met, the identity chain is generated and at least one of first facial image data 610 and/or second facial image data 604 is included in the identity chain 600. Based on a determination that the first matching criteria has been met, the generated identity chain associates the included facial image data (e.g., second facial image data 604 and/or first facial image data 610) with document 300. Is some embodiments, the identity chain 600 is continuously updated and/or includes newly-captured facial image data. Subsequently and/or newly included facial image data in the identity chain 600 are associated with document 300 (e.g., image data 608 of the document).

FIG. 6C illustrates a subsequently captured image data 650 and third first image data 652 in accordance with some embodiments. Captured image data 650 is received after identity chain 600 is generated. For example, captured image data 650 and third first image data is captured after the initial authentication and/or enrollment (t₁>t₀). In some embodiments, captured image data 650 of a person 402 (FIGS. 4 and 5) includes third facial image data 652 and third portion 654 of third facial image data 652. Captured image data 650 is received by an image capturing device 200 such as the first image capturing device 200a as described with regard to FIG. 4 or the second image capturing device 200b as described with regard to FIG. 5. In some embodiments, the image data 650 are image frames from video sequences. In some embodiments, the image data 650 are image frames captured as single still images.

In some embodiments, third facial image data 652 is compared with respective facial image data of identity chain 600 to determine if second matching criteria is met. For example, third facial image data 652 is compared with second facial image data 604 (and/or first facial image data 610), where second facial image data 604 (and/or first facial image data 610) is associated with document 300. In some embodiments, a portion third facial image 654 is compared with a respective portion (e.g., eyes, nose, mouth, less than all of a full face, etc.) of the respective facial image data of identity chain 600. For example, eyes, mouth, and nose of captured image data 650 (portion of third facial image data 654) are compared with eyes, mouth, and nose of respective facial image data of identity chain 600 (e.g., portion of second facial image data 606 (and/or a portion of first facial image data 612)), where the respective facial image data of identity chain 600 is associated with document 300. In some embodiments, third facial image data 652 is compared with a plurality of facial image data included in identity chain 600. In some embodiments, in accordance with a determination that the second matching criteria is met, third facial image data 652 (or captured image data 650) is included in identity chain 600 and associated with document 300.

In some embodiments, if it is determined that invalid facial image data (e.g., facial image data that fails to meet matching criteria (e.g., first or second matching criteria) and/or other criteria) was improperly added to the identity chain 600, facial image data is removed from the identity chain 600. In some embodiments, if facial image data is determined to improperly meet the second matching criteria and added to the identity chain 600, the each added facial image data is removed from the identity chain 600 (e.g., identity chain 600 reverted to a state when it was first generated). For example, if third facial image data 610 is added to identity chain 600 improperly, then third facial image data and/or other added facial image data is removed from identity chain 600 until at least one of the first facial image data 610 and/or the second facial image data 606 remain (e.g., whichever facial image data was included when identity chain 600 was generated). In other words, identity chain 600 is updated to reflect the initial state as when it was first generated (e.g. with at least one of the first facial image data 610 and/or the second facial image data 606 remain).

In some embodiments, second matching criteria is based on the first matching criteria and the identity chain 600. For example, included images in the identity chain 600 are used to determine the second matching criteria. In some embodiments, the second matching criteria is updated for each included image in identity chain 600. In some embodiments, the second matching criteria is updated periodically (e.g., daily, weekly, monthly, etc.). In some embodiments, the second matching criteria is updated when facial image data is removed from identity chain 600. For example, if identity chain 600 is reverted back to a state when it was first generated, the second matching criteria is updated to include the changes in identity chain 600.

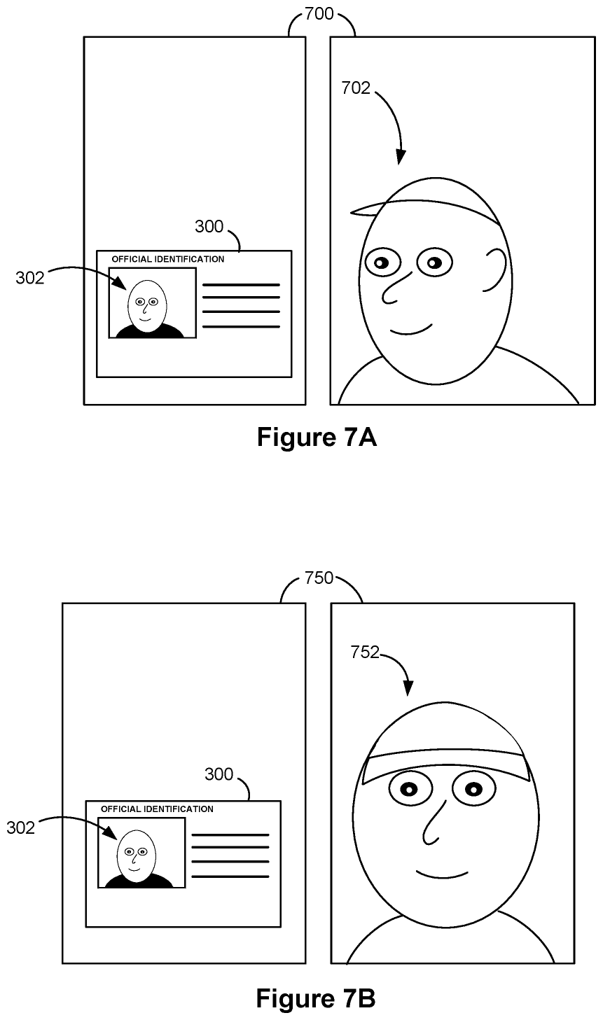

FIG. 7A shows first image data 700 that illustrates a first facial image data position 702 and FIG. 7B shows second image data 750 that illustrates a second facial position 752, in accordance with some embodiments.

In FIG. 7A, the first image data 700 shows the face of person 402 oriented toward the person's right side.) When the orientation of the face of the person 402 in the first image data 700 is different from the orientation of the face in the identity chain 600 (e.g., identification image 302 and/or user image data 602), the ability of the image analysis module 106 to determine whether the first facial image matches the identity chain 600 (e.g., identification image 302 and/or user image data 602) may be impeded. In some embodiments, the image analysis module 106 is configured to determine a first facial image data position 702 of the first facial image (e.g., the facial image that has first facial image data position 702) and a facial position of the identity chain 600 (e.g., identification image 302 and/or user image data 602.) In some embodiments, if the first facial image data position 702 is not sufficiently similar to the second facial position in the identity chain (e.g., identification image 302 or user image data 602) for image analysis module 106 to determine whether matching criteria are met, the computing system 100 transmits a facial position matching request to the image capturing device 200.

For example, in accordance with a determination by the image analysis module 106 that a facial position adjustment is needed, the computing system 100 transmits to the image capturing device 200 a facial position adjustment request, which includes a message such as “please turn your head to the left.” In some embodiments, in response to receiving the transmitted request, the image capturing device 200 displays or otherwise outputs this message (e.g., via an output device 232). In some embodiments, in response to receiving the transmitted request (e.g., subsequent to displaying the received message), image capturing device 200 captures a new image data 750, which includes new facial image data 752, as shown in FIG. 7B, and sends the new image 750 to the computing system 100. In some embodiments, the computing system 100 performs image analysis on the new image data 750.

In some embodiments, determining whether a first facial image in a first facial image data position 702 and the identity chain 600 meet facial position matching criteria includes determining whether a location of one or more facial features (e.g., right eye, left eye, mouth, nose, and/or other identified facial curve or protrusion) detected in the identity chain 600 (e.g., identification image 302 and/or user image data 602) are also detected in the first facial image in the first facial image data position 702. If the one or more facial features in the second facial image are not detected in the first facial image data position 702 of the first image, the computing system 100 transmits to the image capturing device 200 a facial position adjustment request (e.g., including a message such as, “please turn your head to the left,” “please turn your head to the right,” “please tilt your head upward,” or “please tilt your head downward”).

In some embodiments, determining whether a first facial image in a first facial image data position 702 and identity chain 600 image meet facial position matching criteria includes determining whether a face in the first facial image data position 702 is at least partially obstructed (e.g., partially covered by a hat) and/or determining whether a face in the identity chain 600 is at least partially obstructed (e.g., covered by a finger). If an obstruction is detected, the computing system 100 transmits to image capturing device 200 a facial position adjustment request (e.g., including a message such as, “please remove your hat,” or “please move your finger so that it is not covering the picture of your face”).

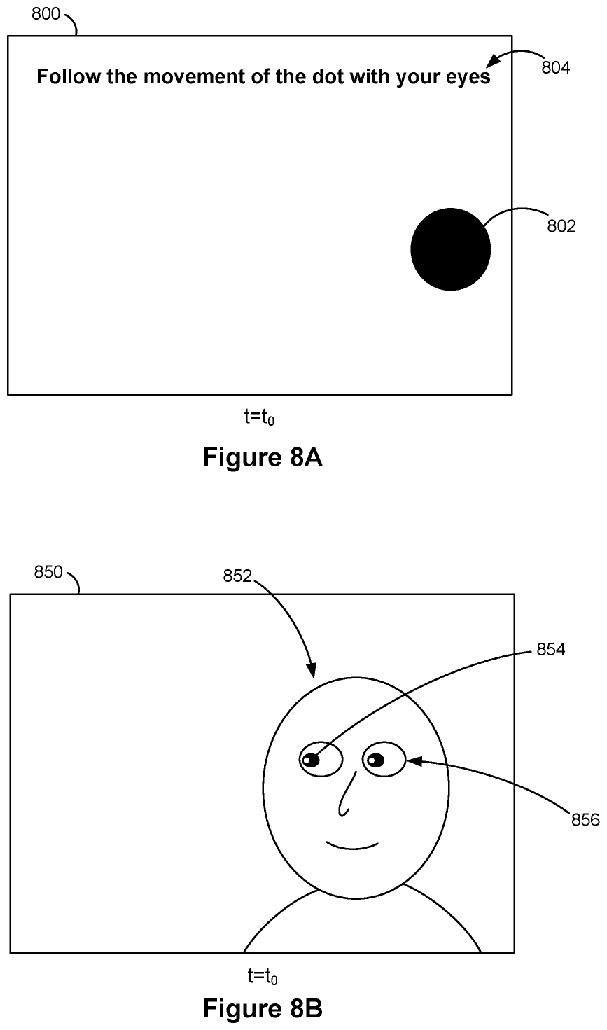

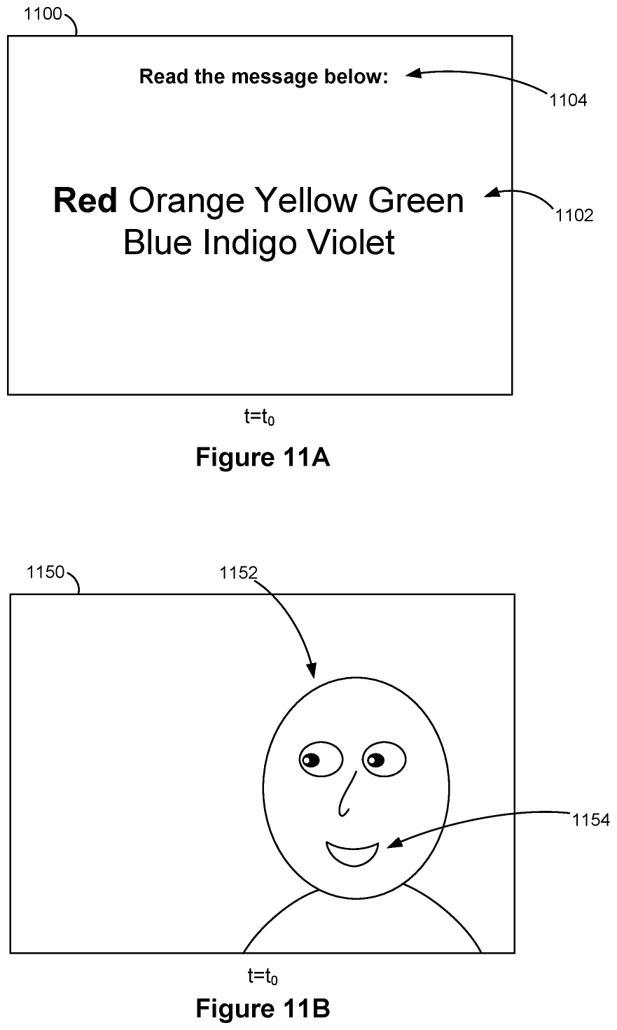

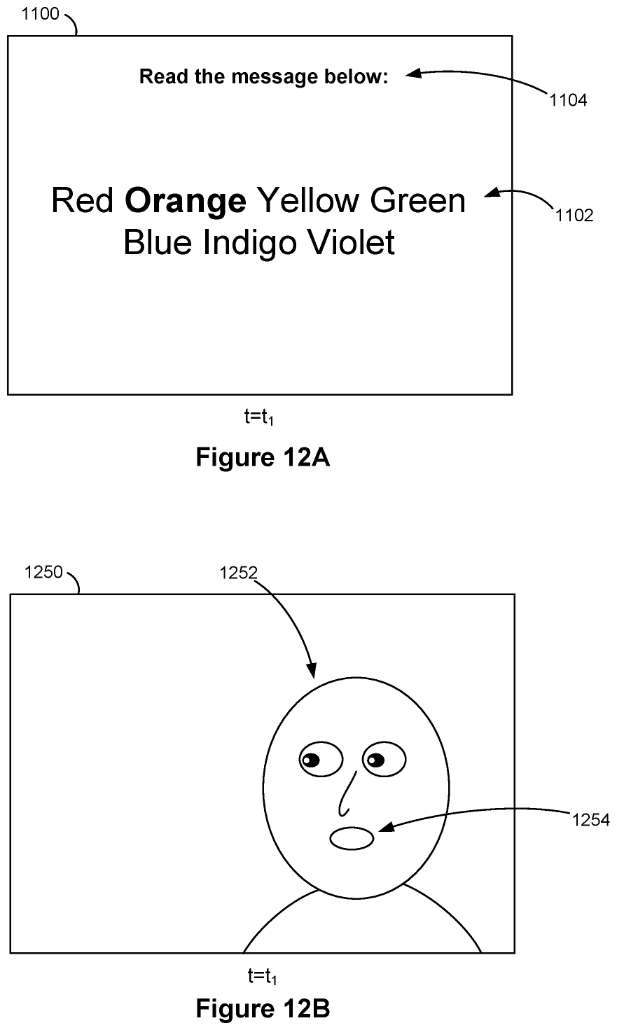

FIGS. 8A-8B, 9A-9B, 10A-10B, 11A-11B, and 12A-12B illustrate user interfaces and captured images associated with liveness assessments, in accordance with some embodiments. For example a liveness assessment assesses movement of a person that occurs in response to an instruction that is displayed or output by a speaker. In some embodiments, a liveness assessment provides additional protection against unauthorized access by ensuring that the person attempting to gain authorization (e.g., the person 402 who is presenting a document 300) is a live individual capable of particular movements in response to instructions. For example, the liveness assessment is used to ensure that a still image cannot be used to gain fraudulent access to a system. In some embodiments, the displayed instruction is randomly, pseudorandomly, or cyclically generated (e.g., so that a user must respond in real time to a prompt that is not predictable prior to the time of the access attempt). FIGS. 8A-8B, 9A-9B, and 10A-10B illustrate use of eye-tracking to for liveness assessment, and FIGS. 11A-11B, and 12A-12B illustrate use of language content in a message for liveness assessment.

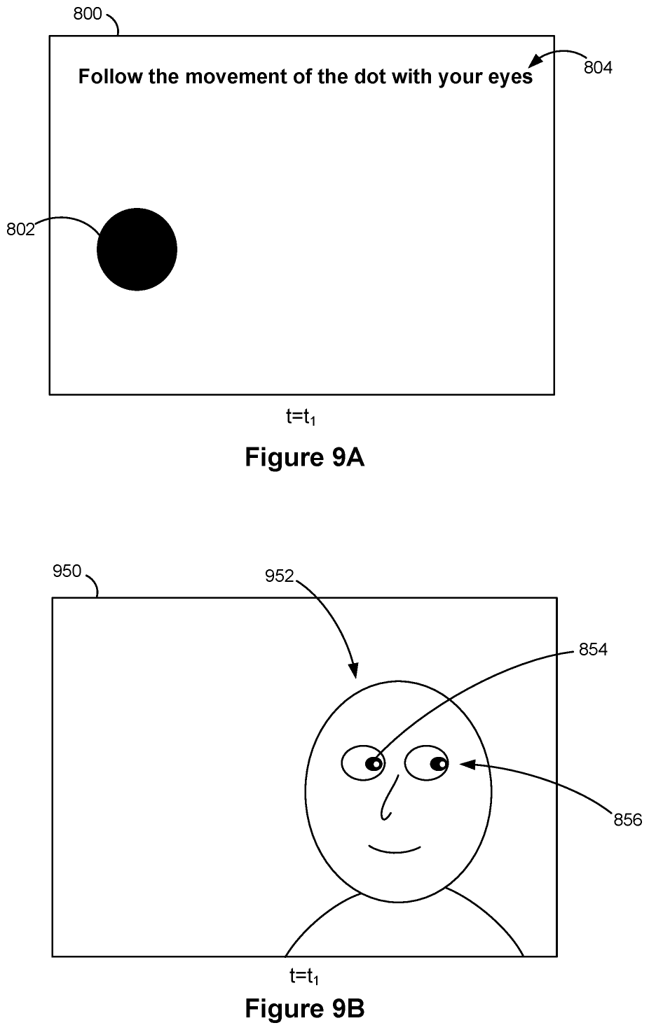

FIGS. 8A and 9A illustrate a user interface 800 that displays a moving target 802 for liveness verification, in accordance with some embodiments. FIG. 8A illustrates a first state of the user interface 800, which is displayed at a first time (t₀) and FIG. 9A illustrates a second state of the user interface 800 as displayed at a second time (t₁), which is later than the first time. The user interface 800 is displayed by a display (e.g., an output device 232) of the image capturing device 200 (e.g., 200a or 200b). In some embodiments, the moving target 802 is an animated image, such as an animated dot. In some embodiments, the moving target 802 moves across the user interface 800 (e.g., side-to-side, as shown in FIGS. 8A and 9A, vertically, diagonally, sinusoidally, and/or along another path). In some embodiments, the path of movement of the moving target 802 is a pre-defined path, a randomly-generated path, a pseudorandomly generated path, or a path that is randomly, pseudorandomly, or cyclically selected from a pre-defined set of paths. In some embodiments, the user interface 800 displays a prompt (e.g., instructive text 804) to provide instructions to a user (e.g., the person 402) for moving a facial feature to satisfy the liveness criteria.

FIGS. 8B and 9B illustrate captured images (850, 950) that are captured at the first time (t₀) and the second time (t₁), respectively, while the user interface 800 is displayed. In some embodiments, the captured images 850 and 950 are frames of a video or still images captured by a camera 218. The captured images 850 and 950 include a first facial image 852 and a second facial image 952, respectively, of the person 402. In some embodiments, one or more facial features (e.g., one or more parts of one or both eyes 856, such as pupils, retinas, and/or irises 854) of the person 402 are tracked. For example, a change in the position the one or more facial features from the first image 850 to the second image 950 is determined and compared to a path of movement of the moving target 802 displayed in the user interface 800. In this way, a person 402 provides liveness verification by moving one or more facial features (e.g., changing a direction of view of the person's eyes 856) in accordance with the path of movement of the moving target 802.

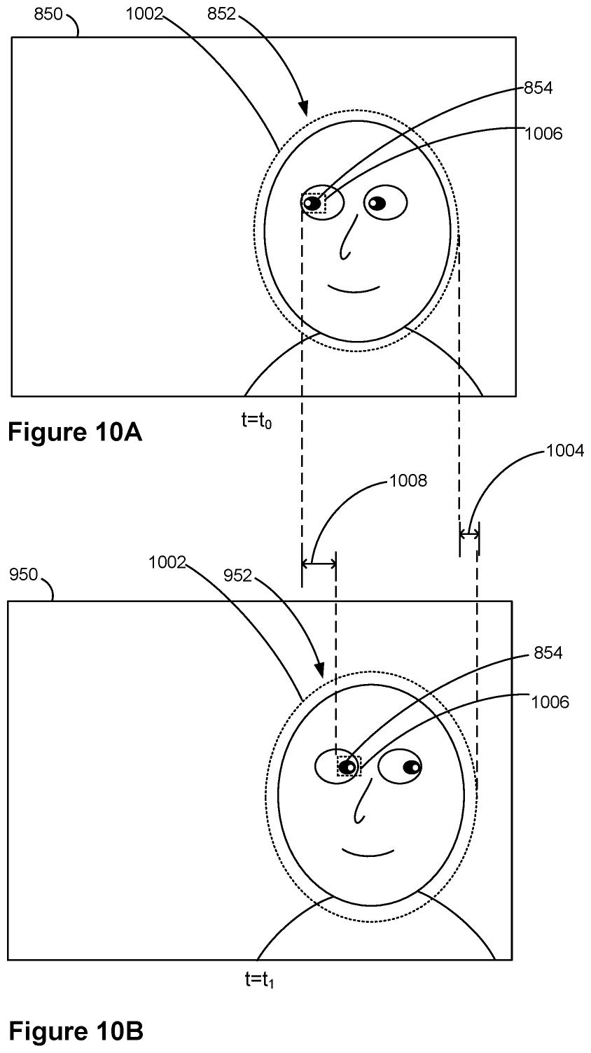

In some embodiments, to meet the movement criteria for a liveness assessment, movement of a facial feature must exceed a threshold distance (e.g., relative to movement of a boundary of the person's face). FIGS. 10A-10B illustrate movement of an eye (specifically, the iris 854) relative to movement of a facial image 852 of a person 402. For example, the eye movement illustrated in FIGS. 10A-10B occurs as the user interface 800 displays a moving target 802, as illustrated in FIGS. 8A and 9A. FIG. 10A illustrates the first image 850 (also shown in FIG. 8B) including the first facial image 852 of the person 402 at the first time (t₀). A facial border 1002 corresponds to the outline of the first facial image 852 (e.g., as determined using an image processing technique, such as edge detection). FIG. 10B illustrates the second image 950 (also shown in FIG. 9B) including the second facial image 952 of the person 402 at the second time (t₁). The face of person 402 has moved in the time between t₀ and t₁, by an amount illustrated by the facial border movement distance 1004. In some embodiments, to satisfy the movement criteria for a liveness assessment, movement of the iris 854 (or movement of a determined iris border 1006 that corresponds to the iris 854), as illustrated by the iris movement distance 1008, must exceed movement of facial border 1002 (e.g., by at least a threshold amount).

FIGS. 11A and 12A illustrate a user interface 1100 that displays language content 1102 for liveness verification, in accordance with some embodiments. FIG. 11A illustrates a first state of a user interface 1100 that is displayed at a first time (t₀) and FIG. 12A illustrates a second state of the user interface 1100 as displayed at a second time (t₁), which is later than the first time. The user interface 1100 is displayed by a display (e.g., an output device 232) of an image capturing device 200 (e.g., 200a or 200b). In some embodiments, the language content 1102 is a word, a set of words (e.g., a phrase and/or a sentence), a set of sentences, a letter, a set of letters, a gibberish word, and/or a set of gibberish words. In some embodiments, the language content 1102 is predetermined language content, randomly generated language content, and/or pseudorandomly generated language content. In some embodiments, the language content 1102 is cyclically, randomly, and/or pseudorandomly selected from a set of predetermined language content items. In some embodiments, respective words in a set of words are sequentially highlighted (e.g., shown with a visually distinguishing feature such as a size, font, bolding, italicizing, and/or underlining that distinguishes the respective word from other words) in order to indicate at a particular time that the person 402 is to read a respective word from the language content 1102. In some embodiments, the user interface 1100 displays or outputs by an audio output a prompt (e.g., instructive text 1104) to provide instructions to a user (e.g., the person 402) for speaking language content 1102 that is displayed or otherwise output.

FIGS. 11B and 12B illustrate captured images 1150 and 1250, which are captured at the first time (t₀) and the second time (t₁), respectively, while the user interface 1100 is displayed. In some embodiments, the captured images 1150 and 1250 are frames of a video or still images captured by a camera 218. The captured images 1150 and 1250 include facial images 1152 and 1252, respectively, of the person 402. In some embodiments, a position of the mouth 1154 within facial image 1152 and/or a position of the mouth 1254 within the facial image 1252 is determined. One or more mouth shape parameters (e.g., an extent to which the mouth is open and/or a roundness of the mouth shape) in one or more captured images (e.g., 1150 and 1250) is determined and compared with one or more mouth shapes that correspond to the displayed language content 1102. The person 402 provides liveness verification by speaking in response to displayed or otherwise output language content 1102. As the message is spoken, the person's mouth makes mouth shapes that correspond to stored mouth shape information.

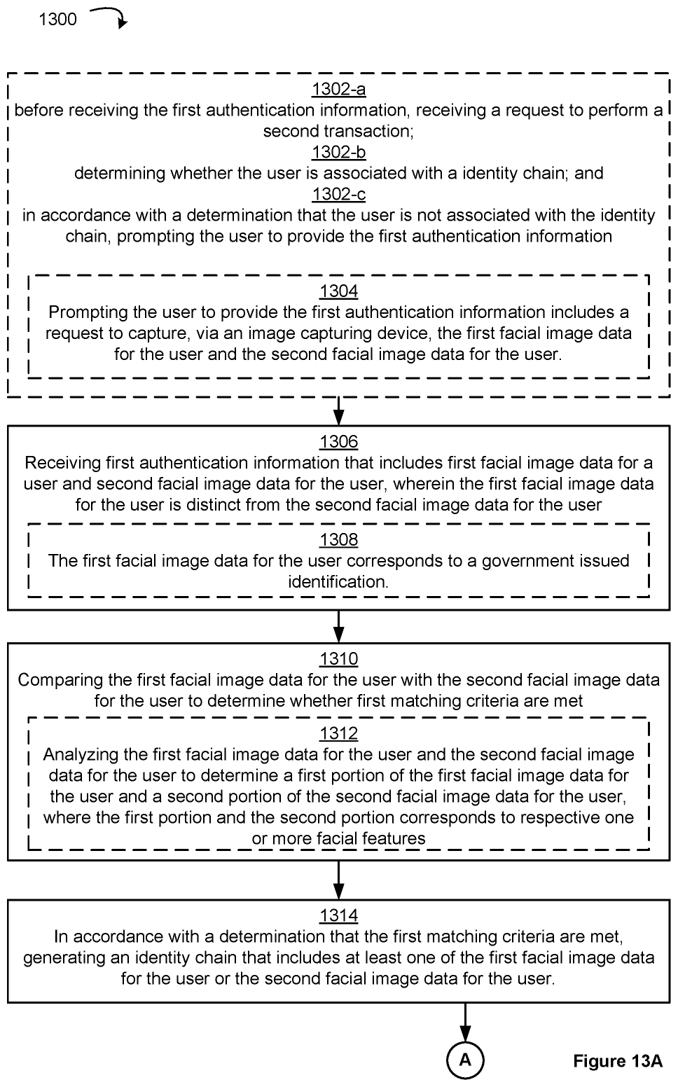

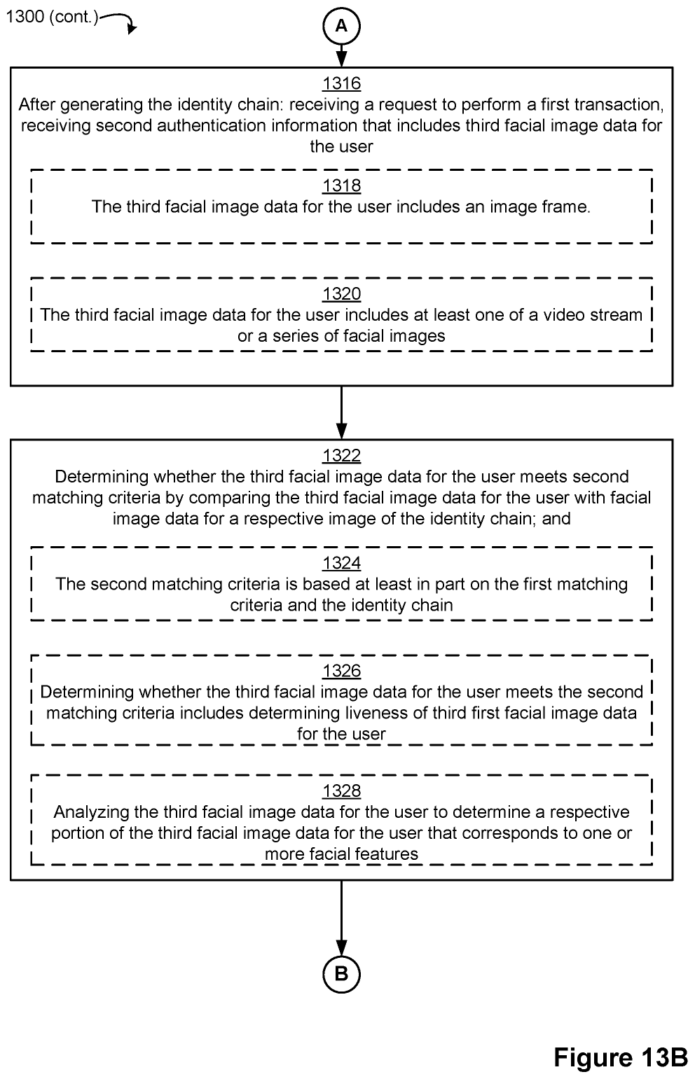

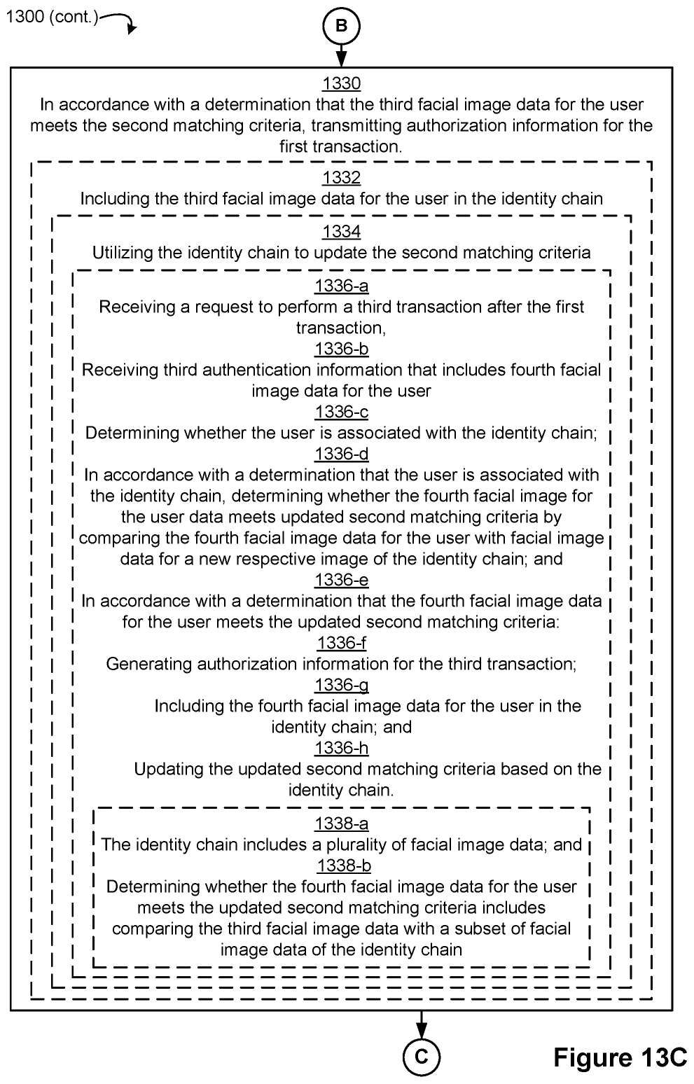

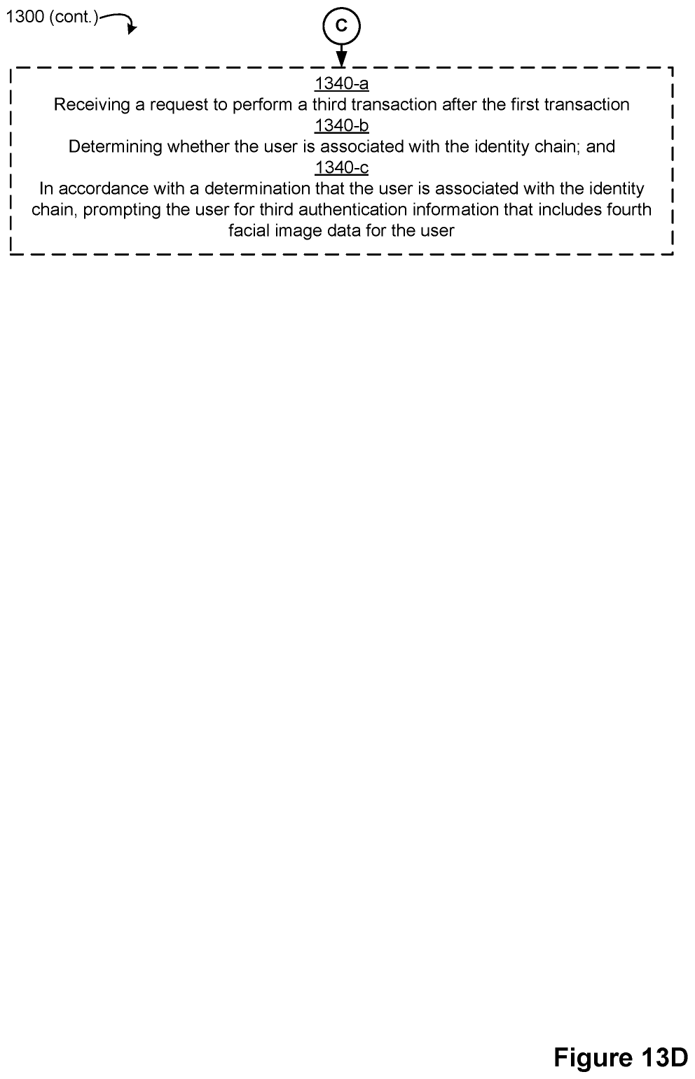

FIGS. 13A-13D are flow diagrams illustrating a method 1300 for authenticating a user using facial image comparison, in accordance with some embodiments. The method 1300 is performed at a device, such as a computing system 100. For example, instructions for performing the method 1300 are stored in the memory 102 and executed by the processor(s) 136 of the computing system 100. In FIGS. 13A-13D, dotted outlines indicate optional operations.

System 100 receives (1306) first authentication information that includes first facial image data for the user and second facial image data for the user, where the first facial image data for the user is distinct from the second facial image data for the user. In some embodiments, the first facial image data is previously-authenticated image data. In some embodiments, the first facial image data for the user corresponds to (e.g., was obtained from) a government issued identification (1308) (e.g., or another issued identification). For example, a new user that seeks to register and/or authenticate themselves would provide first authentication information to begin the authentication process. In some circumstances, the first authentication information include a picture a photo identification. In some embodiments, the first facial image data is image data derived from a picture of a photo identification provided during enrollment of the user. In some embodiments, the first facial image data and the second image data are received concurrently as part of an enrollment request (e.g., a request to authenticated the first facial image data).

In some embodiments, a system 100 receives (1302-a) a request to perform a transaction (e.g. a second transaction) before the system 100 has received authentication information (e.g. first authentication information) from a user; the system 100 determines (1302-b) whether the user is associated with an identity chain; and in accordance with a determination that the user is not associated with the identity chain, the system 100 prompts (1302-c) the user to provide the authentication information (e.g. first authentication information). For example, system 100 receives a request from a new user to perform a transaction, the system determines that the new user is not associated with an identity chain (e.g. has not been previously authenticated) and, in turn, prompts the new user to provide the authentication information that includes facial image data of person 402 and an image of a document for the person 402. In some embodiments, a transaction requires authorization to grant access (e.g., a data access, a device access, and/or facility) access request) and/or to execute a particular action and/or agreement. Additionally and/or alternatively, in some embodiments, prompting (1304) the user to provide the authentication information includes a request to capture, via an image capturing device 200, a first facial image data for the user and a second facial image data for the user.

Returning to the process, system 100 compares (1310) the first facial image data 610 for the user with the second facial image data 604 for the user to determine whether first matching criteria are met. In some embodiments, system 100 analyzes (1312) the first facial image data for the user 610 and the second facial image data for the user 604 to determine a first portion 612 of the first facial image data for the user 610 and a second portion 606 of the second facial image data for the user 604, where the first portion 612 and the second portion 606 corresponds to respective one or more facial features (e.g., nose, eyes, mouth, less than all of a full face, etc.). For example, system 100 receives an image of a government issued identification (e.g., an example of document 300) that includes first facial image data for the user 610 and a second image of the user 602 that includes second facial image data for the user 604, system 100 identifies a first portion 612 corresponding to one or more facial features (e.g., eyes, nose, mouth, less than all of a full face, etc.) of the first facial image data 610 and a second portion 606 corresponding to one or more facial features of the second facial image data 604. In some embodiments, the first and the second portions of the respective facial image data (e.g. 606 and 604) are used to determine whether that matching criteria is met.

System 100, in accordance with a determination that the first matching criteria are met, generates (1314) an identity chain that includes at least one of the first facial image data for the user or the second facial image data for the user. In some embodiments, identity chain 600 is associated (e.g., rooted) to the image data 608 of the document (e.g., document 300) such that subsequent image captures of document 300 are not needed and/or required. For example, the facial image data of identity chain is rooted to the image data 608 of the document (and document 300) and allow for subsequent verification of additional facial image data received by the user without document 300.

After generating the identity chain, system 100 receives (1316) a request to perform a first transaction and second authentication information that includes third facial image data 652 for the user. As illustrated in FIG. 6C, the captured image data 650, captured via the image capturing device 200, includes third facial image data 652 captured at a time t₁ that is distinct from a time to of the initial authentication. In some embodiments, the third facial image data 652 for the user includes an image frame (1318). In some embodiments, the third facial image data 652 for the user includes at least one of a video stream or a series of facial images (1320). In some embodiments, the request to perform the first transaction does not include an image of an identifying document (e.g., a photo identification).

System 100 determines (1322) whether the third facial image data 652 for the user meets second matching criteria by comparing the third facial image data 652 for the user with facial image data for a respective image of the identity chain 600. For example, the third facial image data 652 can be compared with the second facial image data 604, the first facial image data 610, and/or with any other facial image data included in the identity chain.

In some embodiments, the system 100 determines one or more parameters (e.g., shape of face, location of facial features such as eyes, mouth, and nose relative to one another and/or relative to an outline of the face, relative sizes of facial features, and/or distances between facial features) of facial image data for a respective image of the identity chain 600 and uses the one or more parameters of the respective image of the identity chain 600 to identify corresponding parameters in the third facial image data 652. In some embodiments, the one or more parameters of the respective image of the identity chain 600 and the corresponding parameters in the third facial image data 652 are used to determine if the second matching criteria is met.

In some embodiments, the second matching criteria is based at least in part on the first matching criteria and the identity chain (1324). For example, the first matching criteria is used to determine initial second matching criteria and, after the identity chain 600 is generated, at least a respective image of the identity chain is used to determine the second matching criteria.

In some embodiments, the system 100 determines (1326) whether the third facial image data 652 for the user meets the second matching criteria includes determining liveness of third first facial image data 652 for the user. For example, liveness determined by using one or more liveness challenges (e.g., as described with regard to FIGS. 8A-8B, 9A-9B, 10A-10B, 11A-11B, and 12A-12B).

In some embodiments, system 100 analyzes (1328) the third facial image data 652 for the user to determine a respective portion (e.g., 654) of the third facial image data 652 for the user that corresponds to one or more facial features (e.g. eyes, mouth, nose, etc.). For example, system 100 determines a location of a facial feature (e.g., an iris of at least one eye) within the third facial image data 652 of the captured image data 650 and within a respective image of the identity chain 600 (e.g., second facial image data 604 and/or first facial image data 610), and compares a color of the facial feature (e.g., a color of at least one pixel) in the third facial image data 652 of the captured image data 650 with the color of the facial feature in the respective identity chain 600 (e.g., second facial image data 604 and/or first facial image data 610) to determine whether the captured image data 650 and the respective identity chain 600 (e.g., identification image 302 and/or user image data 602) meet the second matching criteria. In another example, system 100 determines a location of a first facial feature (e.g., a nose) within the third facial image data 652 of the captured image data 650 and within respective images of the identity chain (e.g., second facial image data 604 and/or first facial image data 610 of the image data that corresponds to the user image data 602 and/or identification image 302.) In a further example, the system 100 determines a location of a second facial feature (e.g., a left eye) within the third facial image data 652 of the captured image data 650 and within a respective image of the identity chain 600 (e.g., second facial image data 604 and/or first facial image data 610.) A first distance between the first facial feature and the second facial feature in the third facial image data 652 of the captured image data 650 is determined. A second distance between the first facial feature and the second facial feature in the respective image of the identity chain 600 (e.g., second facial image data 604 and/or first facial image data 610.) The first distance (e.g., relative to the size of captured image data 650 in the third facial image data 652) is compared with the second distance (e.g., relative to the size of the respective image of the identity chain 600, e.g., first facial image data 610 in the identification image 302 and/or the second facial image data 604 in the user image data 602) to determine whether the third facial image data 652 and the respective image of the identification chain 600 meet the second matching criteria. Although the above examples are representative of the second matching criteria, a similar process is used to determine whether the first matching criteria is met.

Additionally and/or alternatively, in some embodiments, system 100 determines a respective portion (e.g. 654) of the third facial image data 652 from a plurality of image frames (e.g., image frames of a video) to compare with the respective image of the identity chain 600 (e.g. a respective portion such as first portion 612 of image data 608). For example, the system uses edge detection techniques to determine a region and/or outline (e.g., third facial image portion 654) of the third facial image data 652 and/or other techniques to determine distance, size, shape, curve features, color, and/or relative properties of one or more portions of the third facial image data 652 and he respective image of the identity chain 600 (e.g., second facial image data 604 and/or first facial image data 610). In some embodiments, system 100 determines a shape of a face outline within (e.g. portion) the third facial image data 652 of the captured image data 650 and within the respective identity chain 600 (e.g., second facial image data 604 and/or first facial image data 610), and compares the shape of the face in the third facial image data 652 of the captured image data 650 with the shape of the face in the respective identity chain 600 (e.g., second facial image data 604 and/or first facial image data 610) to determine whether the captured image data 650 and the respective image of identity chain 600 (e.g., identification image 302 and/or user image data 602) meet the second matching criteria.

Optionally, in some embodiments, system 100 generates the third facial image data 652 by compositing a plurality of respective portions of respective image frames from the plurality of image frames that correspond to the captured image data 650. For example, if a segment of the face in the captured image data 650 is obstructed in a first frame and a distinct segment of the face in the captured image data 650 is obstructed in a second frame, the obstructed segment of the face in the second frame can be replaced with a corresponding unobstructed segment of the face from the first frame.

In accordance with a determination that the third facial image data 652 for the user meets the second matching criteria, the system 100 transmits (1330) authorization information for the first transaction. In some embodiments, in accordance with a determination that the third facial image data 652 for the user meets the second matching criteria, system 100 includes (1332) (e.g., adds) the third facial image data 652 for the user in the identity chain 600. Including additional facial image data in the identity chain 600 improves the accuracy of the authentication process by making a robust set of image data available to authenticate the user.

In some embodiments, if it is determined that invalid facial image data (e.g., facial image data that fails to meet matching criteria (e.g., first or second matching criteria) and/or other criteria) was improperly added to the identity chain 600, the system 100 removes from the identity chain 600 additional facial image data until at least one of the first facial image data 610 or the second facial image data 606 remain. In other words, identity chain 600 is updated to reflect the initial state as when it was first generated (e.g. with at least one of the first facial image data 610 or the second facial image data 606 remain). Additionally and/or alternatively, in some embodiments, in some embodiments, the system 100 determines that facial image data and/or image data was improperly added to the identity chain 600 via a quality control process. The quality control process identifies (e.g. flags) improperly added facial image data and/or image data to the identity chain 600 by determining, periodically (e.g. each day, each week, each month, etc.), that a respective image of the identity chain 600 fails to meet matching criteria (e.g. first matching criteria, second matching criteria, and/or other criteria) is flagged by a later (that determines that image data fails to meet authorization criteria, authenticated criteria, or other criteria).

In some embodiments, system 100 utilizes (1334) the identity chain 600 (e.g., identity chain 600 that has been updated to include additional facial image data) to update the second matching criteria. Updating the second matching criteria enables system 100 to improve the matching criteria, increase accuracy over time, and account for a user's changes over time. In some embodiments, the second matching criteria is updated each time the identity chain 600 is modified (e.g. new facial image data is added and/or the identity chain 600 is reset). In some embodiments, the second matching criteria is updated periodically (e.g. each day, each week, each month, etc.).

In some embodiments, system 100 receives (1336-a) a request to perform a third transaction after the first transaction and receives (1336-b) third authentication information that includes fourth facial image data (e.g., captured similar to captured image data 650 and third facial image data 652) for the user. System 100 further determines (1336-c) whether the user is associated with the identity chain and, in accordance with a determination that the user is associated with the identity chain, determines (1336-d) whether the fourth facial image for the user data meets updated second matching criteria by comparing the fourth facial image data for the user with facial image data for a new respective image of the identity chain 600. For example, the system determines whether the fourth facial image data for the user matches the third facial image data, which has been added to the identity chain. In some embodiments, the identity chain includes facial image data for a plurality of images, wherein the plurality of images were authenticated at different times. In accordance with a determination that the fourth facial image data for the user meets (1336-e) the updated second matching criteria (e.g., matches facial image data corresponding to any of the images in the plurality of images of the image chain), system 100 generates (1336-f) authorization information for the third transaction, includes (1336-g) (e.g., adds) the fourth facial image data for the user in the identity chain 600, and updates (1336-h) the updated second matching criteria based on the identity chain 600.

In some embodiments, the identity chain includes (1338-a) a plurality of facial image data. In some embodiments, determining whether the fourth facial image data for the user meets the updated second matching criteria includes (1338-b) comparing the third facial image data with a subset of facial image data of the identity chain

In some embodiments, system 100 receives (1340-a) a request to perform a third transaction after the first transaction, determines (1340-b) whether the user is associated with the identity chain, and, in accordance with a determination that the user is associated with the identity chain, prompts (1340-c) the user for third authentication information that includes fourth facial image data for the user (e.g., and does not include an image of a photo identification).

In some embodiments, in accordance with a determination that the captured image data 650 (e.g. third facial image data 652 or portion of third facial image data 654) does not meet the second matching criteria, the device forgoes generates authorization information for the first transaction. In some embodiments, in accordance with a determination that the captured image data 650 (e.g. third facial image data 652 or portion of third facial image data 654) does not meet the second matching criteria, the device transmits authorization denial information to the image capturing device 200. Additionally and/or alternatively, in some embodiments, in accordance with a determination that the captured image data 650 (e.g. third facial image data 652 or portion of third facial image data 654) does not meet the second matching criteria, the device transmits, to the image capturing device, a facial position adjustment request. Examples of facial position adjustment requests are discussed above with regard to FIGS. 7A and 7B.

In some embodiments, in lieu of receiving captured image data from an image capturing device 200 that is remote from the computing system 100, the computing system 100 captures the captured image data. For example, the computing system 100 captures the captured image data using a biometric input device 142, a camera (not shown) that is a component of the computing system 100, or a local camera (not shown) that is a peripheral device of the computing system 100. In this way, the same system that captures the image data also analyzes the image data as described with regard to FIGS. 13A-13D. For example, in some embodiments, a kiosk (e.g., similar to the kiosk 200b as illustrated in FIG. 5) includes a computing system 100 with a camera that captures an image of the person 402 and the document 300.

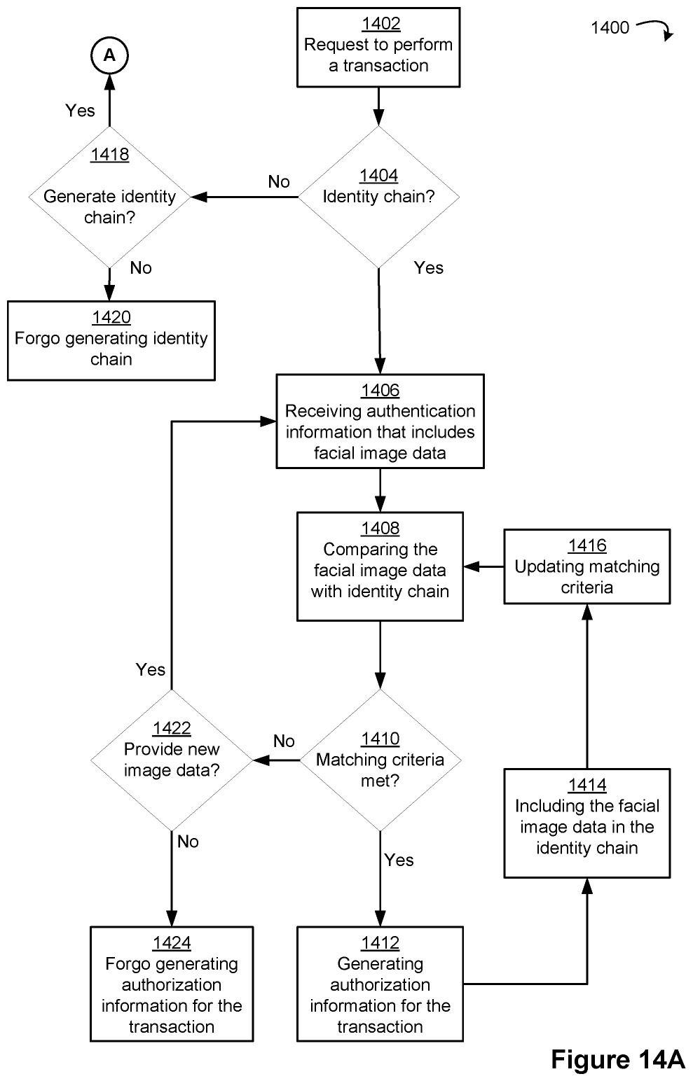

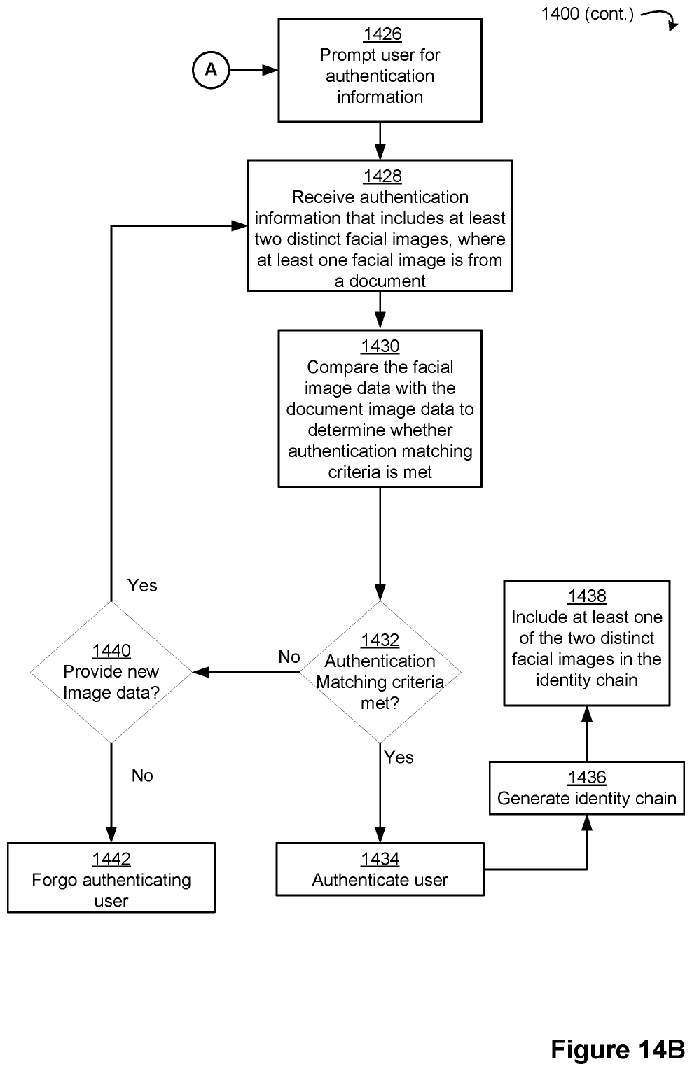

FIGS. 14A-14B are flow diagram illustrating a method for determining whether a person is authorized based on identity chain, in accordance with some embodiments. The method is performed at a server 100 and/or other device. For example, instructions for performing the method are stored in the memory 102 and executed by the processor(s) 136 of the server computer system 100. In some embodiments, part or all of the instructions for performing the method are stored in the memory 202 and executed by the processor(s) 220 of the image capturing device 200.

As illustrated in FIG. 14A flow diagram 1400, a request to perform a transaction 1402 is received by a computer system 100. The computer system determines whether or not the user is associated with an identity chain 1404. If the system determines that the user is associated with an identity chain, the user is prompted or a request is made for authentication information and the system authentication information that includes facial image data 1406. The system then compares the facial image data with the identity chain 1408. The system then determines whether matching criteria has been met 1410 to authenticate the facial image. If the system determines that the matching criteria has been met, then the system generates authorization information for the transaction 1412 and includes (e.g., stores) the facial image data in the identity chain 1414. The system updating matching criteria 1416 based on the facial image data included in the identity chain 1414. The updating matching criteria 1416 is used for future transactions requested by a user or another person. By continuously including new image data that has been authorized by the matching criteria, the system promotes continuous learning.

If, on the other hand, the system determines that the matching criteria has not been met, a user is prompted to provide new facial image data 1422. If the user agrees to provide new image data, the system repeats steps 1406-1410, as discussed above, until a final determination is made. If the user decides not to provide new image data, then the system forgoes generating authorization information for the transaction 1424.

If the system determined that the user is not associated with an identity chain 1404, then the system prompts or requests the user to generate an identity chain 1418. If the user decides not to generate the identity chain, then the system forgoes 1420 generating authorization information for the transaction. On the other hand, if the user decides to generate the identity chain, then the system prompts the user for authentication information 1426 (e.g., enrolment) as shown in FIG. 14B.

In prompting the user for authentication information 1426, the system requests for at least two distinct facial images where at least one facial image is from a document. The system receives authentication information that includes at least two distinct facial images, where at least one facial image is from a document, from the user 1428. The system compares the facial image data with the document image data to determine whether authentication matching criteria is met 1430. If the system determines that the authentication matching criteria has been met 1432, then the system authenticates the user 1434 and generates the identity chain 1436 for the user. After the identity chain is generated 1436 for the user, the system includes 1438 at least one of the two distinct facial images in the identity chain. If the system determines that the authentication matching criteria has not been met 1432, then a request or prompt for new image data is made 1440 is made to the user. If the user decides not to provide new image data 1440, then the system forgoes authenticating user 1442. If the user decides to provide new image data 1440, then the system repeats steps 1428-1438, as described above, until a final determination is made.

Features of the present invention can be implemented in, using, or with the assistance of a computer program product, such as a storage medium (media) or computer readable storage medium (media) having instructions stored thereon/in which can be used to program a processing system to perform any of the features presented herein. The storage medium (e.g., the memory 102 and the memory 202) can include, but is not limited to, high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. In some embodiments, the memory 102 and the memory 202 include one or more storage devices remotely located from the CPU(s) 120 and 220. The memory 102 and the memory 202, or alternatively the non-volatile memory device(s) within these memories, comprises a non-transitory computer readable storage medium.

Communication systems as referred to herein (e.g., the communication system 141 and the communication system 234) optionally communicate via wired and/or wireless communication connections. Communication systems optionally communicate with networks (e.g., the networks 150 and 152), such as the Internet, also referred to as the World Wide Web (WWW), an intranet and/or a wireless network, such as a cellular telephone network, a wireless local area network (LAN) and/or a metropolitan area network (MAN), and other devices by wireless communication. Wireless communication connections optionally use any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 102.11a, IEEE 102.11ac, IEEE 102.11ax, IEEE 102.11b, IEEE 102.11g and/or IEEE 102.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A computer-implemented method, comprising:
at a computing system including one or more processors and memory storing one or more programs configured for execution by the one or more processors:
receiving first authentication information that includes first facial image data for a user and second facial image data for the user, wherein the first facial image data for the user is distinct from the second facial image data for the user;
comparing the first facial image data for the user with the second facial image data for the user to determine whether first matching criteria are met;
in accordance with a determination that the first matching criteria are met, generating an identity chain that includes at least one of the first facial image data for the user or the second facial image data for the user;
after generating the identity chain:
receiving a request to perform a first transaction;
receiving second authentication information that includes third facial image data for the user;
determining whether the third facial image data for the user meets second matching criteria by comparing the third facial image data for the user with facial image data for a respective image of the identity chain; and
in accordance with a determination that the third facial image data for the user meets the second matching criteria, transmitting authorization information for the first transaction.

2. The method of claim 1, wherein the first facial image data for the user corresponds to an issued identification.

3. The method of claim 1, wherein the second matching criteria is based at least in part on the first matching criteria and the identity chain.

4. The method of claim 1, further comprising:
before receiving the first authentication information, receiving a request to perform a second transaction;
determining whether the user is associated with the identity chain; and
in accordance with a determination that the user is not associated with the identity chain, prompting the user to provide the first authentication information.

5. The method of claim 4, wherein prompting the user to provide the first authentication information includes a request to capture, via an image capturing device, the first facial image data for the user and the second facial image data for the user.

6. The method of claim 1, further comprising:
receiving a request to perform a third transaction after the first transaction, determining whether the user is associated with the identity chain; and
in accordance with a determination that the user is associated with the identity chain, prompting the user for third authentication information that includes fourth facial image data for the user.

7. The method of claim 1, further comprising:
in accordance with the determination that the third facial image data for the user meets the second matching criteria, including the third facial image data for the user in the identity chain.

8. The method of claim 7, further comprising utilizing the identity chain to update the second matching criteria.

9. The method of claim 8, further comprising:
receiving a request to perform a third transaction after the first transaction;
receiving third authentication information that includes fourth facial image data for the user;
determining whether the user is associated with the identity chain;
in accordance with a determination that the user is associated with the identity chain, determining whether the fourth facial image data for the user meets updated second matching criteria by comparing the fourth facial image data for the user with facial image data for a new respective image of the identity chain; and
in accordance with a determination that the fourth facial image data for the user meets the updated second matching criteria:
generating authorization information for the third transaction;
including the fourth facial image data for the user in the identity chain; and
updating the updated second matching criteria based on the identity chain.

10. The method of claim 9, wherein the identity chain includes a plurality of facial image data; and
determining whether the fourth facial image data for the user meets the updated second matching criteria includes comparing the third facial image data with a subset of facial image data of the identity chain.

11. The method of claim 1, wherein the third facial image data for the user includes an image frame.

12. The method of claim 1, wherein the third facial image data for the user includes at least one of a video stream or a series of facial images.

13. The method of claim 1, wherein determining whether the third facial image data for the user meets the second matching criteria includes determining liveness of third first facial image data for the user.

14. The method of claim 1, wherein comparing the first facial image data for the user with the second facial image data for the user includes analyzing the first facial image data for the user and the second facial image data for the user to determine a first portion of the first facial image data for the user and a second portion of the second facial image data for the user, where the first portion and the second portion corresponds to respective one or more facial features.

15. The method of claim 1, wherein determining whether the third facial image data for the user meets the second matching criteria by comparing the third facial image data for the user with facial image data for a respective image of the identity chain includes analyzing the third facial image data for the user to determine a respective portion of the third facial image data for the user that corresponds to one or more facial features.

16. The method of claim 1, wherein the computing system includes a server.

17. A computing system, comprising:
one or more processors; and
memory storing one or more programs configured for execution by the one or more processors, the one or more programs including instructions for:
receiving first authentication information that includes first facial image data for a user and second facial image data for the user, wherein the first facial image data for the user is distinct from the second facial image data for the user;
comparing the first facial image data for the user with the second facial image data for the user to determine whether first matching criteria are met;
in accordance with a determination that the first matching criteria are met, generating an identity chain that includes at least one of the first facial image data for the user or the second facial image data for the user;
after generating the identity chain:
receiving a request to perform a first transaction;
receiving second authentication information that includes third facial image data for the user;
determining whether the third facial image data for the user meets second matching criteria by comparing the third facial image data for the user with facial image data for a respective image of the identity chain; and
in accordance with a determination that the third facial image data for the user meets the second matching criteria, transmitting authorization information for the first transaction.

18. A non-transitory computer-readable storage medium storing one or more programs for execution by a computer system with one or more processor and memory, the one or more programs including instructions for:
receiving first authentication information that includes first facial image data for a user and second facial image data for the user, wherein the first facial image data for the user is distinct from the second facial image data for the user;
comparing the first facial image data for the user with the second facial image data for the user to determine whether first matching criteria are met;
in accordance with a determination that the first matching criteria are met, generating an identity chain that includes at least one of the first facial image data for the user or the second facial image data for the user;
after generating the identity chain:
receiving a request to perform a first transaction;
receiving second authentication information that includes third facial image data for the user;
determining whether the third facial image data for the user meets second matching criteria by comparing the third facial image data for the user with facial image data for a respective image of the identity chain; and
in accordance with a determination that the third facial image data for the user meets the second matching criteria, transmitting authorization information for the first transaction.
